(19) United States
(12) Patent Application Publication
(10) Pub. No.: US 2026/0187182 A1
(43) Pub. Date: Jul. 2, 2026

(54) OPTIMIZING APPARATUS, OPTIMIZATION METHOD, AND MEDIUM

(71) Applicant: Mitsubishi Electric Corporation, Tokyo (JP)

(72) Inventors: Kuniaki SATORI, Tokyo (JP); Nobuyuki YOSHIKAWA, Tokyo (JP)

(73) Assignee: Mitsubishi Electric Corporation, Tokyo (JP)

(21) Appl. No.: 19/547,179

(22) Filed: Feb. 23, 2026

Related U.S. Application Data
(63) Continuation of application No. PCT/JP2023/031067, filed on Aug. 29, 2023.

(51) Int. Cl. G06F 17/11

(52) U.S. Cl. CPC G06F 17/11

(57) ABSTRACT

An optimizing apparatus includes processing circuitry configured to: acquire an original-problem solution which is a solution satisfying a constraint of a combinatorial optimization problem including a plurality of target factors to be combined; divide the plurality of target factors into a plurality of groups on a basis of the original-problem solution, and generate a subproblem being set for each of the plurality of groups; find a solution to the subproblem generated by the subproblem generating unit; generate a candidate solution to the original problem on a basis of the obtained solution to the subproblem; and determine whether it is possible or not possible to update the original-problem solution on a basis of a result of comparison between the generated candidate solution and the acquired original-problem solution.

### CROSS REFERENCE TO RELATED APPLICATION

This application is a Continuation of PCT International Application No. PCT/JP2023/031067, filed on Aug. 29, 2023, which is hereby expressly incorporated by reference into the present application.

### TECHNICAL FIELD

The present disclosure relates to an optimizing apparatus, an optimization method, and a medium.

### BACKGROUND ART

Combinatorial optimization problems are used for various problems in modern society. For example, in fields such as manufacturing and logistics, combinations of factors (locations and products) that minimize the costs associated with placing products in a warehouse are searched for. In such combinatorial optimization problems, typically, a mixed integer programming method (MIP), an evolutionary computation algorithm, and the like are used. However, combinatorial optimization problems often require enormous computation amounts as the problem scales (the numbers of state variables) increase. Accordingly, it is known that optimization is difficult in a large-scale combinatorial optimization problem.

As a method of solving such a combinatorial optimization problem with a large problem scale, there is a technique in which a combinatorial optimization problem with a large problem scale (hereinafter, also referred to as an “original problem”) is divided and converted into a small-scale subproblem. For example, Patent Literature 1 proposes a method of optimizing an original-problem solution by repeatedly performing the procedure of (1) to (3), which are (1) in which, from a large-scale combinatorial optimization problem, only state variables that influence evaluation to a certain degree are extracted, and the combinatorial optimization problem is converted into a subproblem, (2) in which the subproblem is solved, and (3) an original-problem solution is updated with a solution to the subproblem.

### CITATION LIST

### Patent Literature

Patent Literature 1: Japanese Patent No. 7219402

### SUMMARY OF INVENTION

### Technical Problem

In the technique described in Patent Literature 1 (hereinafter, also referred to as the “conventional technique”), when a subproblem is generated, state variables that influence evaluation to a certain degree are extracted to generate a subproblem. Accordingly, there is a problem with the conventional technique that the solution space of the subproblem is a solution space defined by limiting state variables of the original problem, there is a bias in the solution space of the subproblem, and the local search tendency is high.

The present disclosure has been made to solve the problem described above, and an object thereof is to provide an optimizing apparatus that can suppress the local search tendency ┌ of computation of a combinatorial optimization problem by conversion of the combinatorial optimization problem into a subproblem, compared to the conventional technique.

### Solution to Problem

An optimizing apparatus according to the present disclosure includes: processing circuitry configured to: acquire an original-problem solution which is a solution satisfying a constraint of a combinatorial optimization problem including a plurality of target factors to be combined; generate a subproblem by dividing the plurality of target factors into a plurality of groups on a basis of the original-problem solution; find a solution to the subproblem generated; generate a candidate solution to the original problem on a basis of the obtained solution to the subproblem; and determine whether it is possible or not possible to update the original-problem solution on a basis of a result of comparison between the generated candidate solution and the acquired original-problem solution.

### Advantageous Effects of Invention

Since the present disclosure adopts the configuration described above, it is possible to suppress the local search tendency of computation of a combinatorial optimization problem by conversion of the combinatorial optimization problem into a subproblem, compared to the conventional technique.

### BRIEF DESCRIPTION OF DRAWINGS

FIG. 1 is a block diagram illustrating a configuration example of an optimizing apparatus according to a first embodiment.

FIG. 2 is a block diagram illustrating a configuration example of a subproblem generating unit in the first embodiment.

FIG. 3 is a flowchart illustrating an operation example of the optimizing apparatus according to the first embodiment.

FIG. 4 is a flowchart illustrating a specific procedure performed by the subproblem generating unit to generate a subproblem in the first embodiment.

FIG. 5 is a drawing for explaining an application example in a case where the optimizing apparatus according to the first embodiment is applied to a placement optimization problem of products in a warehouse.

FIG. 6 is a drawing for explaining an application example in a case where the optimizing apparatus according to the first embodiment is applied to a placement optimization problem of products in a warehouse.

FIG. 7 is a drawing for explaining the efficacy of an optimizing apparatus for the placement optimization problem of products in a warehouse.

FIG. 8A and FIG. 8B are drawings illustrating hardware configuration examples of the optimizing apparatus according to the first embodiment.

### DESCRIPTION OF EMBODIMENTS

Hereinafter, an embodiment is explained in detail with reference to the drawings.

### First Embodiment

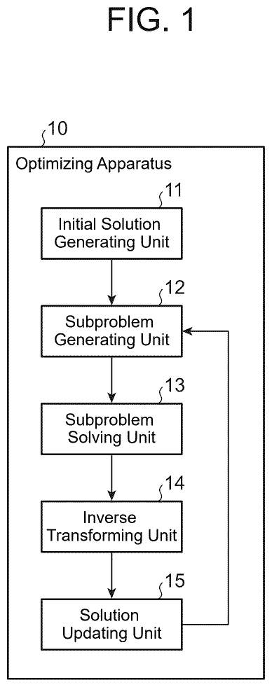

FIG. 1 is a block diagram illustrating a configuration example of an optimizing apparatus 10 according to a first embodiment. For example, as illustrated in FIG. 1, the optimizing apparatus 10 includes an initial solution generating unit 11, a subproblem generating unit 12, a subproblem solving unit 13, an inverse transforming unit 14, and a solution updating unit 15.

The initial solution generating unit 11 generates a solution (hereinafter, also referred to as an “original-problem solution”) satisfying constraints of a combinatorial optimization problem with a large problem scale (original problem) including a plurality of target factors to be combined. At this time, the initial solution generating unit 11 may generate the original-problem solution using any method. For example, the initial solution generating unit 11 may generate the original-problem solution randomly or may generate the original-problem solution on the basis of a simple rule. In addition, the initial solution generating unit 11 may generate the original-problem solution on the basis of an evaluation function of the original problem or may generate the original-problem solution on the basis of domain knowledge.

Note that whereas the optimizing apparatus 10 causes the initial solution generating unit 11 to generate the original-problem solution in the example explained here, this is not the sole example, but the optimizing apparatus 10 may acquire the original-problem solution from an external apparatus. In this case, instead of the initial solution generating unit 11, the optimizing apparatus 10 may include an initial solution acquiring unit to acquire the original-problem solution from the external apparatus.

The subproblem generating unit 12 divides the plurality of target factors included in the original problem into a plurality of groups on the basis of the original-problem solution, and generates a subproblem set for each of the plurality of groups. A specific configuration example of the subproblem generating unit 12 is mentioned later.

The subproblem solving unit 13 solves the subproblem generated by the subproblem generating unit 12. At this time, the subproblem solving unit 13 may solve the subproblem using one or more selected from known techniques such as quantum annealing (Quantum Annealing; QA) in an approximate solution method, an evolutionary computation algorithm (Simulated Annealing; SA, Genetic Algorithm; GA, etc.), and a mixed integer linear programming method (Mixed Integer Programming problem; MIP) in an explicit solution technique.

The inverse transforming unit 14 generates a candidate solution to the original problem on the basis of a solution to the subproblem obtained by the subproblem solving unit 13. Specifically, the inverse transforming unit 14 generates the candidate solution to the original problem by applying, to the original-problem solution, a swapping rule for target factors in each group, the swapping rule being designated on the basis of the solution to the subproblem obtained by the subproblem solving unit 13.

The solution updating unit 15 determines whether it is possible or not possible to update the original-problem solution on the basis of a result of comparison between the candidate solution generated by the inverse transforming unit 14 and the original-problem solution generated by the initial solution generating unit 11. Note that, in a case where the optimizing apparatus 10 includes the initial solution acquiring unit instead of the initial solution generating unit 11, the solution updating unit 15 decides whether it is possible or not possible to update the original-problem solution on the basis of a result of comparison between the candidate solution generated by the inverse transforming unit 14 and the original-problem solution acquired by the initial solution acquiring unit.

In a case where it is decided to update the original-problem solution, the solution updating unit 15 updates the original-problem solution on the basis of the candidate solution generated by the inverse transforming unit 14. On the other hand, in a case where it is decided not to update the original-problem solution, the solution updating unit 15 does not update the original-problem solution.

After the decision by the solution updating unit 15 as to whether it is possible or not possible to perform the updating, the subproblem generating unit 12 determines whether or not a predetermined end condition is satisfied. In a case where it is determined that the end condition is not satisfied, the subproblem generating unit 12 generates a new subproblem on the basis of the original-problem solution after the decision by the solution updating unit 15 as to whether it is possible or not possible to perform the updating.

For example, in a case where it has been decided by the solution updating unit 15 to update the original-problem solution, and the original-problem solution has been updated, the subproblem generating unit 12 generates a new subproblem on the basis of the solution after being updated. In addition, in a case where it has been decided by the solution updating unit 15 not to update the original-problem solution, and the original-problem solution has not been updated, the subproblem generating unit 12 generates a new subproblem on the basis of the un-updated original-problem solution.

The subproblem generating unit 12 repeats generation of a new subproblem based on the original-problem solution until it is determined that the predetermined end condition is satisfied after decision by the solution updating unit 15 as to whether it is possible or not possible to perform updating. For example, the predetermined end condition is whether or not the number of times of generation of a subproblem by the subproblem generating unit 12 has reached a predetermined number of times.

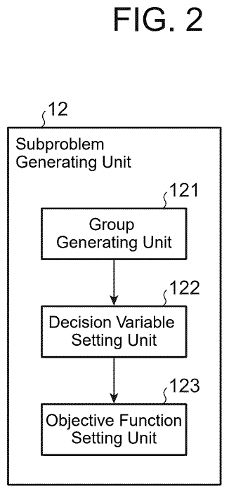

Next, a specific configuration example of the subproblem generating unit 12 is explained with reference to FIG. 2. Note that, in an exemplary case explained in the following explanation, a combinatorial optimization problem which is an original problem is a placement optimization problem in order to provide more specific explanation. The placement optimization problem is an example of a combinatorial optimization problem, and is a problem for determining optimal positions of a plurality of target factors to be combined.

FIG. 2 is a block diagram illustrating a configuration example of the subproblem generating unit 12. For example, as illustrated in FIG. 2, the subproblem generating unit 12 includes a group generating unit 121, a decision variable setting unit 122, and an objective function setting unit 123.

The group generating unit 121 generates a plurality of groups on the basis of an original-problem solution. Specifically, when generating a subproblem for the first time, the group generating unit 121 selects two or more target factors in accordance with any rule on the basis of an original-problem solution (hereinafter, also referred to as an “initial placement solution”) generated by the initial solution generating unit 11, and generates one group. For example, the group generating unit 121 may randomly select two or more target factors from all target factors, select two or more target factors on the basis of evaluation, select two or more target factors on the basis of domain knowledge about the original problem, and so on. Then, the group generating unit 121 generates a plurality of groups each including two or more target factors.

Similarly, when generating a subproblem for the second and subsequent times, the group generating unit 121 selects two or more target factors in accordance with any rule on the basis of the original-problem solution after decision by the solution updating unit 15 as to whether it is possible or not possible to perform updating, and generates one group. For example, the group generating unit 121 may randomly select two or more target factors from all target factors, select two or more target factors on the basis of evaluation, select two or more target factors on the basis of domain knowledge about the original problem, and so on. Then, the group generating unit 121 generates a plurality of groups each including two or more target factors.

In addition, at this time, the group generating unit 121 generates the plurality of groups in such a manner that constraints of the placement optimization problem are satisfied even if the positions of target factors included in each group are swapped. For example, in a case where the placement optimization problem which is the original problem is a problem of optimizing the positions of a plurality of products on shelves, the group generating unit 121 puts a product A and a product B in the same group as long as the constraints of the original problem are satisfied even if the places of the product A and the product B on the shelves are swapped. On the other hand, the group generating unit 121 does not put the product A and the product B in the same group if the constraints of the original problem are not satisfied when the places of the product A and the product B on the shelves are swapped.

The decision variable setting unit 122 sets a decision variable of a subproblem such that the decision variable corresponds to swapping of the positions of target factors included in each group generated by the group generating unit 121.

For example, a method performed by the decision variable setting unit 122 to set the decision variable of the subproblem is as follows. That is, the decision variable of the subproblem corresponds to swapping of the positions of target factors only in each group. That is, the value of the decision variable corresponds to an order swapping pattern of target factors. For example, there are a plurality of possible patterns of an order swapping pattern of target factors in each group such as: swapping the positions of two target factors; shifting the positions of all target factors by N (N is any natural number) rightward or leftward; randomly shuffling the positions of all target factors; and so on.

As the first example, it is assumed that two target factors are included in a group, and target factors A and B are included in the group (group=(A,B)). In this case, since there are only two patterns as positional patterns in the group, the decision variable setting unit 122 sets one binary variable as the decision variable corresponding to this group. Then, the positions of the target factors are not swapped (the positions are maintained) (A,B) when the value of the decision variable is 0, and the positions of the target factors are swapped (B,A) when the value of the decision variable is 1. In this manner or in another manner, the decision variable is set such that the decision variable corresponds to swapping of the positions of target factors only in each group.

As the second example, it is assumed that three target factors are included in a group, and target factors A, B, and C are included in the group (group=(A,B,C)). In this case, since there are six patterns as positional patterns in the group, there are several possible examples of a decision variable that is set such that the decision variable corresponds to reordering of the target factors in the group.

For example, the decision variable setting unit 122 sets one binary variable as the decision variable corresponding to this group. Then, the positions of the target factors are not swapped (the positions are maintained) (A,B,C) when the value of the decision variable is 0, and the positions of all the target factors are shifted rightward (C,A,B) or shifted leftward (B,C,A) when the value of the decision variable is 1. In this manner or in another manner, the decision variable is set such that the decision variable corresponds to swapping of the positions of target factors only in each group.

Alternatively, the decision variable setting unit 122 sets two binary variables as the decision variable corresponding to this group. Then, the positions of the target factors are not swapped (the positions are maintained) (A,B,C) when the value of the decision variable is 00, the positions of all the target factors are shifted rightward (C,A,B) when the value of the decision variable is 01, the positions of all the target factors are shifted leftward (B,C,A) when the value of the decision variable is 10, and the first and last values of the target factors are swapped (C,B,A) when the value of the decision variable is 11. In this manner or in another manner, the decision variable is set such that the decision variable corresponds to swapping of the positions of target factors only in each group.

Note that the setting of a decision variable of a subproblem explained above is merely an example, and the decision variable setting unit 122 may set a decision variable of a subproblem with content other than that above. In this manner, the decision variable setting unit 122 sets a decision variable of a subproblem such that the decision variable corresponds to swapping of the positions of target factors included in each group generated by the group generating unit 121.

The objective function setting unit 123 sets an objective function of a subproblem. At this time, the objective function setting unit 123 sets the objective function of the subproblem assuming that the objective function of the subproblem performs evaluation identical to evaluation of an objective function of the placement optimization problem which is the original problem. Note that the structure of the objective function of the subproblem itself may be different from the structure of the objective function of the original problem since decision variables are different between the subproblem and the original problem. In addition, the objective function of the subproblem set by the objective function setting unit 123 is preferably formulated by a quadratic unconstrained binary optimization problem (Quadratic Unconstrained Binary Optimization; QUBO) since this makes it possible for the subproblem solving unit 13 to solve the subproblem efficiently.

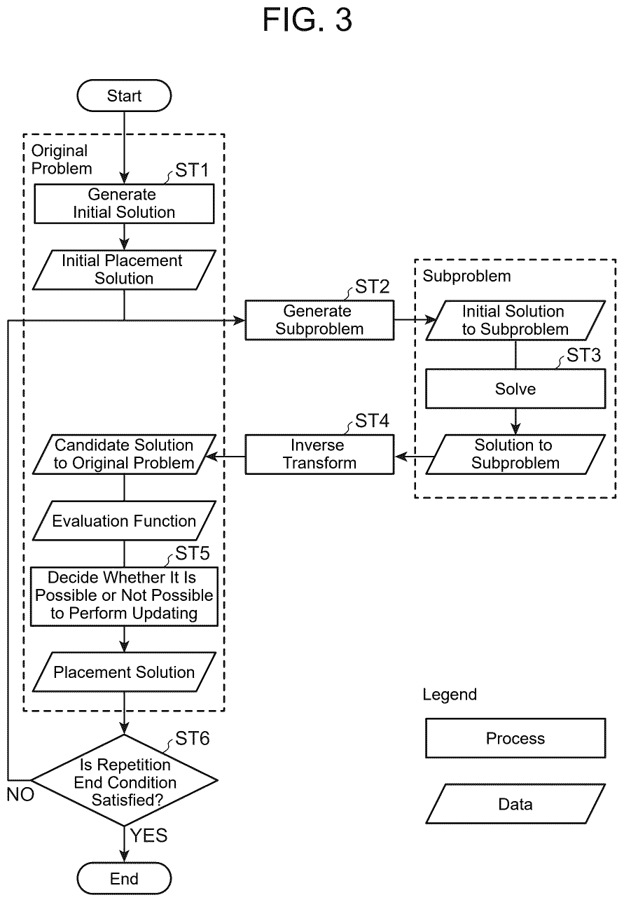

Next, an operation example of the optimizing apparatus 10 illustrated in FIG. 1 is explained. FIG. 3 is a flowchart representing an operation example of the optimizing apparatus 10. Note that, in the flowchart illustrated in FIG. 3, Steps ST1 and ST5 are processing steps in the space of an original problem, ST3 is a processing step in the space of a subproblem, and ST2, ST4, and ST6 are other processing steps.

First, the initial solution generating unit 11 generates a solution (initial placement solution) satisfying constraints of a combinatorial optimization problem with a large problem scale (original problem) using any method (Step ST1).

Next, on the basis of the original-problem solution (initial placement solution) generated by the initial solution generating unit 11 at Step ST1, the subproblem generating unit 12 generates a subproblem (Step ST2).

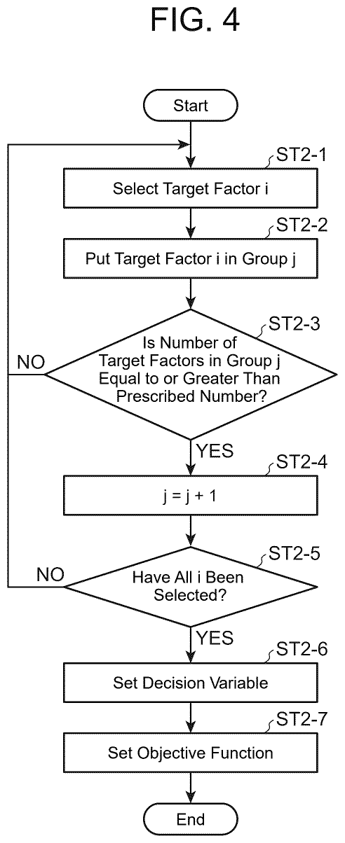

Here, a specific procedure performed by the subproblem generating unit 12 to generate the subproblem is explained with reference to a flowchart illustrated in FIG. 4.

First, on the basis of the original-problem solution (initial placement solution) generated by the initial solution generating unit 11 at Step ST1, the group generating unit 121 of the subproblem generating unit 12 selects a target factor i from a plurality of target factors included in the original problem in accordance with any rule mentioned above (Step ST2-1). Note that i represents an index given to each target factor.

Next, the group generating unit 121 puts the target factor i selected at Step ST2-1 in a group j (Step ST2-2). Note that j represents an index given to each group.

Next, the group generating unit 121 determines whether or not the number of target factors included in the group j is equal to or greater than a predetermined prescribed number (Step ST2-3). In a case where, as a result of the determination, it is determined that the number of target factors included in the group j is not equal to or greater than the prescribed number (Step ST2-3; NO), the process returns to Step ST2-1, and the group generating unit 121 selects the next target factor i from the plurality of target factors included in the original problem. Then, the group generating unit 121 puts the selected next target factor i in the group j (Step ST2-2). Thereafter, the group generating unit 121 repeats the selection of the target factor i and the storage of the target factor i in the group j until it is determined at Step ST2-3 that the number of target factors included in the group j is equal to or greater than the predetermined prescribed number.

On the other hand, in a case where it is determined that the number of target factors included in the group j is equal to or greater than the prescribed number (Step ST2-3; YES), the group generating unit 121 increments j in order to put the target factor i in another group (Step ST2-4).

Next, the group generating unit 121 determines whether or not all the target factors i included in the original problem have been selected (Step ST2-5). In a case where, as a result of the determination, it is determined that not all the target factors i included in the original problem have been selected (Step ST2-5; NO), the process returns to Step ST2-1, and the group generating unit 121 repeats Steps ST2-1 to ST2-5 until it is determined that all the target factors i included in the original problem have been selected. On the other hand, in a case where it is determined that all the target factors i included in the original problem have been selected (Step ST2-5; YES), the process proceeds to Step ST2-6.

At Step ST2-6, as mentioned above, the decision variable setting unit 122 sets a decision variable of a subproblem such that the decision variable corresponds to swapping of the positions of target factors included in each group generated by the group generating unit 121 (Step ST2-6).

Next, as mentioned above, as an objective function of the subproblem, the objective function setting unit 123 sets an objective function that performs evaluation identical to evaluation of an objective function of the placement optimization problem which is the original problem (Step ST2-7). Thereafter, the process returns.

Next, the subproblem solving unit 13 solves the subproblem generated by the subproblem generating unit 12 at Step ST2 (Step ST3). At this time, the subproblem solving unit 13 solves the subproblem using, as the initial solution to the subproblem, the original-problem solution (initial placement solution) generated by the initial solution generating unit 11 at Step ST1 in an un-swapped state. The thus-obtained solution to the subproblem represents, for the plurality of groups, which positions of the target factors i are optimal. In other words, the thus-obtained solution to the subproblem represents, for the plurality of groups, a combination of decision variables at the time when the positions of target factors i are optimized.

Next, at Step ST3, the inverse transforming unit 14 generates a candidate solution to the original problem on the basis of the solution to the subproblem obtained by the subproblem solving unit 13 (Step ST4). Specifically, the inverse transforming unit 14 generates the candidate solution to the original problem by applying, to the original-problem solution, a swapping rule for target factors i of each group, the swapping rule being designated on the basis of the solution to the subproblem obtained by the subproblem solving unit 13.

Next, the solution updating unit 15 decides whether it is possible or not possible to update the original-problem solution on the basis of a result of comparison between the candidate solution generated by the inverse transforming unit 14 at Step ST4 and the original-problem solution generated by the initial solution generating unit 11 (Step ST5).

For example, the solution updating unit 15 inputs, to the objective function (evaluation function) of the original problem, the candidate solution generated by the inverse transforming unit 14 at Step ST4, and obtains an evaluation value. Then, the solution updating unit 15 compares the thus-obtained evaluation value with an evaluation value obtained by inputting, to the objective function of the original problem, the original-problem solution generated by the initial solution generating unit 11, and, when the former is a better evaluation value, decides to update the original-problem solution with the candidate solution generated by the inverse transforming unit 14. Then, the solution updating unit 15 updates the original-problem solution with the candidate solution generated by the inverse transforming unit 14. On the other hand, if the latter is a better evaluation value, the solution updating unit 15 decides not to update the original-problem solution. Here, the original-problem solution after the process performed by the solution updating unit 15 is also referred to as a “placement solution.”

Thereafter, the subproblem generating unit 12 determines whether or not a predetermined end condition is satisfied (Step ST6). For example, the predetermined end condition is whether or not the number of times of generation of a subproblem by the subproblem generating unit 12 has reached a predetermined number of times.

In a case where, as a result of the determination, it is determined that the end condition is satisfied (Step ST6; YES), the optimizing apparatus 10 determines the placement solution at that time point as an optimized solution, and ends the process. Note that, as necessary, the optimizing apparatus 10 may output the placement solution on a display unit (not illustrated) such as a display.

On the other hand, in a case where it is determined that the end condition is not satisfied (Step ST6; NO), the process returns to Step ST2, and the subproblem generating unit 12 generates a new subproblem. Note that, in this generation of a new subproblem, the subproblem generating unit 12 generates a new subproblem not on the basis of the original-problem solution (initial placement solution) generated by the initial solution generating unit 11 at Step ST1, but on the basis of the placement solution obtained at Step ST5. Thereafter, the optimizing apparatus 10 repeats Steps ST2 to ST5 until it is determined by the subproblem generating unit 12 at Step ST6 that the end condition is satisfied. Thereby, the original-problem solution (placement solution) is improved.

Next, advantageous effects of the optimizing apparatus 10 according to the first embodiment are explained.

As mentioned above, in the optimizing apparatus 10 according to the first embodiment, a combinatorial optimization problem with a large problem scale is converted into a subproblem which is a problem of swapping the positions of target factors in a group. In this regard, in a case where a combinatorial optimization problem is converted into a subproblem using the conventional technique mentioned above, when the subproblem is generated, target factors (state variables) that influence evaluation to a certain degree are extracted to generate the subproblem. Accordingly, the solution space of the subproblem is a solution space formed by limiting state variables of the original problem, there is a bias in the solution space of the subproblem, and the local search tendency is high. In addition, in the conventional technique, the subproblem is generated by simply limiting decision variables of the original problem. Accordingly, the problem structure does not change, and accordingly the complexity of constraints of the original problem are also inherited by the subproblem.

On the other hand, in the optimizing apparatus 10 according to the first embodiment, as mentioned above, when a subproblem is generated, a decision variable is set such that the decision variable corresponds to swapping of the positions of target factors in a group. Thereby, changes of all decision variables from an original problem become possible. Accordingly, in the optimizing apparatus 10 according to the first embodiment, the bias in the solution space of a subproblem is reduced compared to the conventional technique, and the local search tendency is suppressed compared to the conventional technique. In addition, the possibility of falling into a localized solution is reduced compared to the conventional technique.

In addition, since a decision variable of a subproblem is decided on the basis of an original-problem solution in the optimizing apparatus 10 according to the first embodiment, the subproblem does not inherit constraints of the original problem. Accordingly, in the optimizing apparatus 10 according to the first embodiment, a subproblem of reduced complexity compared to the conventional technique can be generated, and this leads to enhancement of the searchability due to the reduction of the search space. In addition, in the optimizing apparatus 10 according to the first embodiment, by using a binary value as a decision variable of a subproblem, an objective function of the subproblem can be formulated by a quadratic unconstrained binary optimization problem (QUBO), and computation of quantum annealing of a quadratic unconstrained binary optimization problem that might otherwise result in performance deterioration due to constraints becomes easier.

### Specific Application Example

Next, a specific application example of the optimizing apparatus 10 according to the first embodiment is explained. Here, as an example, an application example in a case where the optimizing apparatus 10 according to the first embodiment is applied to a placement optimization problem of products in a warehouse is explained.

In a placement optimization problem of products in a warehouse, it is aimed to minimize shipping time based on the shelf placement of the products. At this warehouse, a crane with two forks is used. This crane can take out two products from shelves simultaneously, and ship the two products. For example, if there are products that are adjacent to each other in the lateral direction of the shelves, the crane can take out (pick) the products from the shelves simultaneously.

For example, as one possible method to shortenshipping time, it is conceivable to place products with high shipment frequencies on shelves with short shipping time (shelves closer to a shipment exit). In addition, if mutually highly-related products are placed on nearby shelves, the products can be picked simultaneously at the time of simultaneous shipment, movement time when the second product is taken out after the first product is taken out can be reduced, and so on, thereby leading to shorter shipping time.

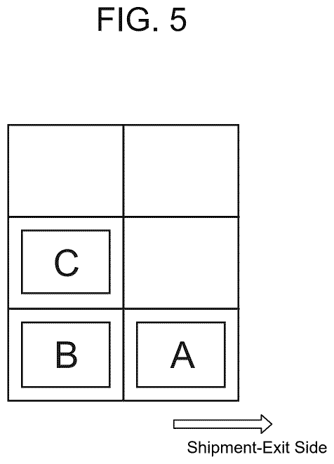

For example, it is assumed that there are shelves in three rows and two columns as illustrated in FIG. 5, and the order of the shipment frequencies of products A, B, and C to be placed on the shelves is A>B>C. At this time, if the products are placed in order of A, B, and C starting from the shelf closest to the side of a shipment exit, the shipping time of a product with a higher shipment frequency becomes shorter, and the shipping time can be shortened. In addition, in a case where the frequency of simultaneous shipment of A and B is high, for example, the crane can simultaneously pick and ship A and B if A and B are placed adjacent to each other in the lateral direction of the shelves as illustrated FIG. 5. Accordingly, the shipping time at the time of simultaneous shipment of A and B can be shortened.

Expected cases regarding a placement optimization problem of this warehouse include a case where optimization is performed when products are to be placed on the shelves in a state where there are no products put on the shelves, a case where optimization is performed when products have already been placed on the shelves, and products are to be additionally placed on the shelves, and the like. Note that optimization considered here is the former example, that is, an example in which products are placed on the shelves in a state where there are no products put on the shelves. Under this condition also, products having already been placed on the shelves can be expressed by fixing decision variables in advance as products having already been placed on the shelves.

In a placement optimization problem of products in a warehouse, objective functions (evaluation functions) by formulation of a quadratic unconstrained binary optimization problem (QUBO) are defined by the following Formulae (1) to (5), for example. The following Formulae (1) to (5) are evaluation functions in a case where it is possible to place and swap all products on all the shelves, and the number of combinations of the products increases explosively as the problem scale increases.

$$Variables$$

$${x}_{s , b} = 1 \to product b is set into shelf s , \qquad ( 1 )$$

$$Minimize$$

$$H ( x ) = \frac{{H}_{c} ( x )}{{\sum }_{x} {H}_{c} ( x )} + {λ}_{b} {H}_{b} ( x ) + {λ}_{s} {H}_{s} ( x ) , \qquad ( 2 )$$

$${H}_{c} ( x ) = {\sum }_{s ∈ S} {\sum }_{b ∈ B} {E}_{s} ( s , b ) {x}_{s , b} + {\sum }_{{s}_{0} \neq {s}_{1} ∈ S} {\sum }_{{b}_{0} \neq {b}_{1} ∈ B} {E}_{d} ( {s}_{0} , {s}_{1} , {b}_{0} , {b}_{1} ) {x}_{{s}_{0} , {b}_{0}} {x}_{{s}_{1} , {b}_{1}} . \qquad ( 3 )$$

$$subject to$$

$${H}_{b} ( x ) = {\sum }_{b ∈ B} {( {\sum }_{s ∈ S} {x}_{s , b} - 1 )}^{2} , \qquad ( 4 )$$

$${H}_{s} ( x ) = {\sum }_{{b}_{0} < {b}_{1} ∈ B} {\sum }_{s ∈ S} {x}_{s , {b}_{0}} {x}_{s , {b}_{1}} . \qquad ( 5 )$$

For example, the decision variable x in Formula (1) is a binary value for formulation by the quadratic unconstrained binary optimization problem (QUBO). Here, the decision variable x represents that a product is placed on a shelf.

In addition, for example, as in Formula (2) and Formula (3), the objective functions are calculated from the total of a time expectation value Es of shipment of one product b from a location (shelf) s and a time expectation value Ed of shipment of two products b0 and b1 from locations (shelves) s0 and s1. In addition, constraints are for preventing the decision variable x from giving an inexecutable solution. For example, Hb in Formula (4) is a product constraint for preventing two or more products from being placed on the same shelf, and Hs in Formula (5) is a shelf constraint for preventing the same product from being placed on a plurality of shelves.

An example of generation of a subproblem from the placement optimization problem (original problem) described above is illustrated. Note that, as settings of the subproblem, for example, the number of target factors in one group is two, and a decision variable is a binary value. Thereby, formulation of an objective function of the subproblem by a quadratic unconstrained binary optimization problem (QUBO) becomes easier to perform without requiring constraints. In addition, as settings of the subproblem, as mentioned above, a plurality of groups are generated on the basis of an original-problem solution, and the decision variable of the subproblem is set such that the decision variable corresponds to each group generated. At this time, constraints of the original problem are satisfied no matter how the positions of target factors are swapped in each group. In addition, the decision variable of the subproblem corresponds to swapping of the positions of target factors included in each group.

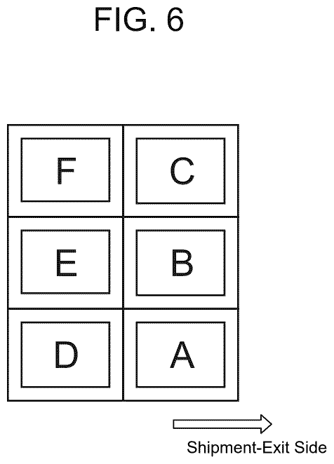

For example, in a case of associating the decision variable of the subproblem with groups, the group generating unit 121 generates three groups using any method since the number of target factors in each group is two. For example, in a case where there are products A to F as illustrated in FIG. 6, the group generating unit 121 generates groups (A,F), (C,D), and (E,B).

At this time, since swapping of the positions of target factors (products) in each group can be expressed if there is one binary variable, the decision variable setting unit 122 allocates one binary decision variable X to each group.

At this time, for example, the decision variable of the subproblem is expressed as X=x_1, x_2, x_3. x_1 corresponds to swapping of (A,F), x_2 corresponds to swapping of (C,D), and x_3 corresponds to swapping of (E,B). For example, the positions of A and F are not swapped (the places are maintained) when the value of the decision variable x_1 is 0, but the positions of A and F are swapped when the value of the decision variable x_1 is 1. In this manner, an operation to swap the positions of the products is performed depending on the value of the decision variable x_1. In addition, the values of the other decision variables x_2 and x_3 similarly correspond to operations to swap the positions of the products.

Note that whereas it is assumed in the example in FIG. 6 that all the products are placed on the shelves, there are vacant shelves in a case where the number of products is smaller than the number of shelves. In such a case, a case where there are vacant shelves can be expressed by placing dummy products on the vacant shelves, and performing optimization assuming that the dummy products are not shipped.

Next, examples of formulae in a case where the objective function of the subproblem is formulated by a quadratic unconstrained binary optimization problem (QUBO) with settings of the subproblem mentioned above are illustrated.

$$Variables$$

$${x}_{a} = 1 \to swap positions within pair a . \qquad ( 6 )$$

$$Minimize$$

$$H ( x ) = {H}_{c} ( x ) , \qquad ( 7 )$$

$${H}_{c} ( x ) = {\sum }_{\text{?}} ( ( {E}_{\text{?}} ( {s}_{\text{?}} , {b}_{\text{?}} ) + {E}_{\text{?}} ( {s}_{\text{?}} , {b}_{\text{?}} ) ) ( 1 - {x}_{\text{?}} ) + ( {E}_{\text{?}} ( {s}_{\text{?}} , {b}_{\text{?}} ) + {E}_{\text{?}} ( {s}_{\text{?}} , {b}_{\text{?}} ) ) {x}_{\text{?}} ) + {\sum (}_{\text{?}} ( 1 - {x}_{\text{?}} ) ( 1 - {x}_{\text{?}} ) {\sum }_{\text{?}} {\sum }_{\text{?}} {E}_{d} ( {s}_{\text{?}} , {s}_{\text{?}} , {b}_{\text{?}} , {b}_{\text{?}} ) + {x}_{\text{?}} ( 1 - {x}_{\text{?}} ) {\sum }_{\text{?}} {\sum }_{\text{?}} {E}_{d} ( {s}_{\text{?}} , {s}_{\text{?}} , {b}_{\text{?}} , {b}_{\text{?}} ) + ( 1 - {x}_{\text{?}} ) {x}_{\text{?}} {\sum }_{\text{?}} {\sum }_{\text{?}} {E}_{d} ( {s}_{\text{?}} , {s}_{\text{?}} , {b}_{\text{?}} , {b}_{\text{?}} ) + {x}_{\text{?}} {x}_{\text{?}} {\sum }_{\text{?}} {\sum }_{\text{?}} {E}_{d} ( {s}_{\text{?}} , {s}_{\text{?}} , {b}_{\text{?}} , {b}_{\text{?}} ) . \qquad ( 8 )$$

$$\text{?} \text{indicates text missing or illegible when filed}$$

For example, the decision variable x in Formula (6) is a binary value for formulation by the quadratic unconstrained binary optimization problem (QUBO). The value 0 of the decision variable x corresponds to not swapping the positions of products (maintaining the positions), and the value 1 of the decision variable x corresponds to swapping the positions of products.

In addition, the objective functions in Formula (7) and Formula (8) calculate time expectation values of shipment of products in a case where the positions of the products are swapped. That is, the objective functions in Formula (7) and Formula (8) evaluate the time expectation values similarly to the objective functions of the original problem in Formula (2) and Formula (3). Note that, since the structure of the decision variable of the subproblem is designed to satisfy constraints of the original problem, there are no constraints equivalent to Formula (4) and Formula (5) mentioned above.

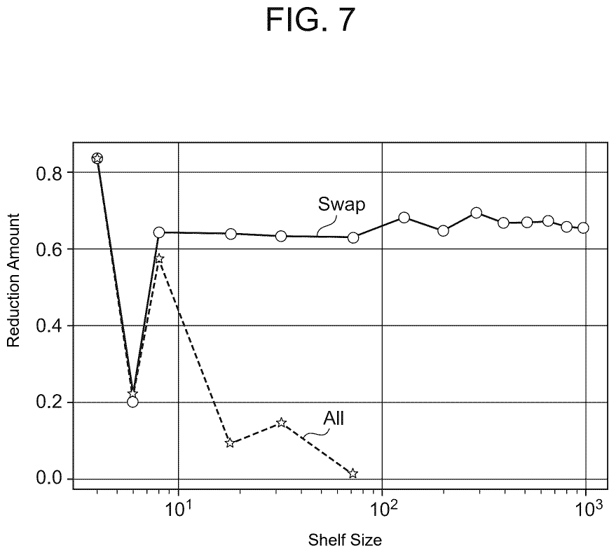

Next, the efficacy of the optimizing apparatus 10 for the placement optimization problem mentioned above is explained. FIG. 7 is a drawing illustrating results of comparison between a case where the original problem, that is, a problem considering the placement of all products on all shelves, is formulated (Formula (1) to Formula (5) mentioned above), and a case where a problem considering the conversion of the original problem into a subproblem, and the repeated solution optimization is formulated (Formula (6) to Formula (8) mentioned above).

It is assumed that, as a comparison method, the reduction amount of shipping time expectation values relative to the original-problem solution (initial placement solution) in relation to various shelf sizes is compared. For example, in FIG. 7, the horizontal axis represents the shelf size, and the vertical axis represents the reduction amount of shipping time expectation values relative to the initial placement solution. Note that a larger value of the reduction amount of shipping time expectation values represented on the vertical axis is better, and a larger value of the shelf size represented on the horizontal axis indicates higher problem difficulty. In addition, in FIG. 7, a graph denoted by All depicts a case where a problem is formulated considering the placement of all products on all shelves, and a graph denoted by Swap represents a case where a problem is formulated considering the conversion of the original problem into a subproblem, and the repeated solution optimization. Note that, in this example, the original problem and the subproblem were solved using quantum annealing using the HyBridQA solver installed on a quantum computer of D-Wave Quantum Inc.

As illustrated in FIG. 7, regarding the graph denoted by All, the reduction amount decreases as the shelf size (problem scale) increased, and computation became impossible due to the occurrence of an embedded error on the side of the quantum computer of D-Wave Quantum Inc. because the problem became too complex at an intermediate stage. In contrast, regarding the graph denoted by Swap, the reduction amount did not decrease even if the shelf size increased, and computation did not become impossible. On the basis of this, it can be known that the optimizing apparatus 10 achieves the expansion of a computable area and the enhancement of searchability by being able to reduce the computation amount as compared with the conventional technique.

Note that whereas a combinatorial optimization problem which is an original problem is a placement optimization problem of products in a warehouse in an exemplary case explained in the explanation described above, the optimizing apparatus 10 according to the first embodiment can be applied also to problems other than a placement optimization problem of products in a warehouse.

For example, whereas the placement optimization problem mentioned above is for optimizing the spatial positions of products (target factors), an order optimization problem (e.g. a traveling salesman problem, etc.) is for optimizing the temporal positions of target factors, and subproblems by swapping of positions can be generated. Accordingly, the optimizing apparatus 10 according to the first embodiment can be applied also to order optimization problems.

In addition, in an integer optimization problem of discrete values, subproblems can be generated by generating decision variables of the current solution and groups of selectable decision variables. Accordingly, the optimizing apparatus 10 according to the first embodiment can be applied also to integer optimization problems of discrete values. In addition, the optimizing apparatus 10 according to the first embodiment can be applied also to optimization problems of consecutive values by discretizing consecutive values. That is, the optimizing apparatus 10 according to the first embodiment can be applied to any problems as long as it is possible to generate groups from a decision variable candidate group in which target factors can be swapped, such that decision variables and constraints of combinatorial optimization problems which are original problems are satisfied.

Typically, it is known that, in the combinatorial optimization problems mentioned above, the numbers of combinations become enormous as the problem scales increase, and, considering memory-size restrictions and computation time constraints, it is preferable to perform computation by dividing the combinatorial optimization problems into subproblems with smaller problem scales. the optimizing apparatus 10 according to the first embodiment can generate subproblems in the manner mentioned above. Accordingly, a reduction in local search tendency and an enhancement of the search efficiency compared to the conventional technique can be expected.

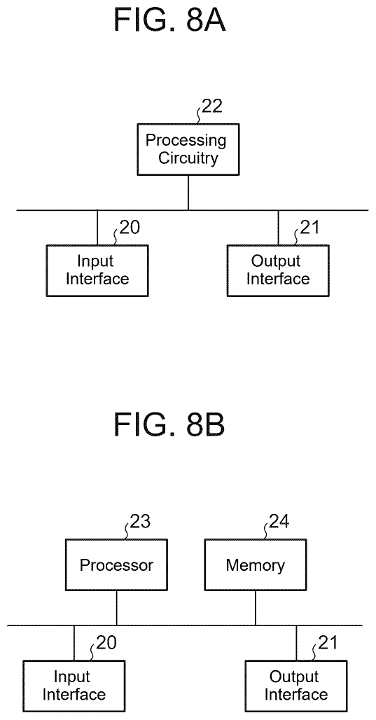

Next, a hardware configuration example of the optimizing apparatus 10 according to the first embodiment is explained with reference to FIG. 8. Respective functions of the initial solution generating unit 11, the subproblem generating unit 12, the subproblem solving unit 13, the inverse transforming unit 14, and the solution updating unit 15 in the optimizing apparatus 10 are implemented by processing circuitry 22. That is, the optimizing apparatus 10 includes the processing circuitry 22 for executing the respective processes from Step ST1 to Step ST6 illustrated in FIG. 3, and the respective processes from Step ST2-1 to Step ST2-7 illustrated in FIG. 4. The processing circuitry 22 may be dedicated hardware or may be a Central Processing Unit (CPU) or a Graphics Processing Unit (GPU) to execute programs stored on a memory. In addition, for example, the processing circuitry 22 may be installed on external hardware, such as the quantum computer of D-Wave Quantum Inc. mentioned above, that can communicate with the optimizing apparatus 10.

FIG. 8A is a block diagram illustrating hardware configuration to implement functions of the optimizing apparatus 10. FIG. 8B is a block diagram illustrating hardware configuration to execute software to implement functions of the optimizing apparatus 10. In FIG. 8A and FIG. 8B, an input interface 20 is an interface to relay data that is to be output from an external apparatus to the optimizing apparatus 10, and is related to a target problem. An output interface 21 is an interface to relay an optimal solution to the target problem output from the optimizing apparatus 10 to a downstream external apparatus.

In a case where the processing circuitry is the processing circuitry 22 of dedicated hardware illustrated in FIG. 8A, for example, the processing circuitry 22 is a single circuit, a composite circuit, a programmed processor, a parallel-programmed processor, an Application Specific Integrated Circuit (ASIC), a Field-Programmable Gate Array (FPGA), or a combination of these. Functions of the initial solution generating unit 11, the subproblem generating unit 12, the subproblem solving unit 13, the inverse transforming unit 14, and the solution updating unit 15 included in the optimizing apparatus 10 may be implemented by different pieces of processing circuitry, or the functions may be implemented collectively by one piece of processing circuitry.

In a case where the processing circuitry is a processor 23 illustrated in FIG. 8B, functions of the initial solution generating unit 11, the subproblem generating unit 12, the subproblem solving unit 13, the inverse transforming unit 14, and the solution updating unit 15 included in the optimizing apparatus 10 are implemented by software, firmware, or a combination of software and firmware. Note that software or firmware is written as programs, and stored on a memory 24.

By reading out and executing the programs stored on the memory 24, the processor 23 implements functions of the initial solution generating unit 11, the subproblem generating unit 12, the subproblem solving unit 13, the inverse transforming unit 14, and the solution updating unit 15 included in the optimizing apparatus 10. For example, the optimizing apparatus 10 includes the memory 24 for storing programs execution of which by the processor 23 results in execution of the respective processes from Step ST1 to Step ST6 illustrated in FIG. 3, and the respective processes from Step ST2-1 to Step ST2-7 illustrated in FIG. 4. These programs cause a computer to execute processing procedures or methods performed by the initial solution generating unit 11, the subproblem generating unit 12, the subproblem solving unit 13, the inverse transforming unit 14, and the solution updating unit 15. The memory 24 may be a computer-readable storage medium having stored thereon programs for causing a computer to function as the initial solution generating unit 11, the subproblem generating unit 12, the subproblem solving unit 13, the inverse transforming unit 14, and the solution updating unit 15.

For example, the memory 24 is a non-volatile or volatile semiconductor memory such as a Random Access Memory (RAM), a Read Only Memory (ROM), a flash memory, an Erasable Programmable Read Only Memory (EPROM), or an Electrically-EPROM (EEPROM), a magnetic disk, a flexible disc, an optical disc, a compact disc, a mini disc, a DVD, or the like.

Some of functions of the initial solution generating unit 11, the subproblem generating unit 12, the subproblem solving unit 13, the inverse transforming unit 14, and the solution updating unit 15 included in the optimizing apparatus 10 may be implemented by dedicated hardware, and the rest may be implemented by software or firmware. For example, functions of the subproblem solving unit 13 are implemented by the processing circuitry 22, which is dedicated hardware, and functions of the initial solution generating unit 11, the subproblem generating unit 12, the inverse transforming unit 14, and the solution updating unit 15 are implemented by the processor 23 reading out and executing programs stored on the memory 24.

In this manner, the processing circuitry 22 can implement the functions by hardware, software, firmware, or a combination of these.

As mentioned above, according to the first embodiment, the optimizing apparatus 10 includes: the solution acquiring unit to acquire an original-problem solution which is a solution satisfying a constraint of a combinatorial optimization problem including a plurality of target factors to be combined; the subproblem generating unit 12 to divide the plurality of target factors into a plurality of groups on the basis of the original-problem solution, and generate a subproblem set for the plurality of groups; the subproblem solving unit 13 to solve a subproblem generated by the subproblem generating unit 12; the inverse transforming unit 14 to generate a candidate solution to the original problem on the basis of a solution to the subproblem obtained by the subproblem solving unit 13; and the solution updating unit 15 to decide whether it is possible or not possible to update the original-problem solution on the basis of a result of comparison between the candidate solution generated by the inverse transforming unit 14 and the original-problem solution acquired by the solution acquiring unit. Thereby, in the optimizing apparatus 10 according to the first embodiment, it is possible to suppress the local search tendency of computation of the combinatorial optimization problem by conversion of the combinatorial optimization problem into the subproblem, compared to the conventional technique.

In addition, the subproblem generating unit 12 determines whether or not a predetermined end condition is satisfied after the decision by the solution updating unit 15 as to whether it is possible or not possible to perform the updating, and, in a case where it is determined that the end condition is not satisfied, generates a new subproblem on the basis of the original-problem solution after the decision by the solution updating unit 15 as to whether it is possible or not possible to perform the updating. Thereby, in the optimizing apparatus 10 according to the first embodiment, it is possible to improve the original-problem solution on the basis of a solution to the new subproblem.

In addition, the combinatorial optimization problem is a placement optimization problem, and the subproblem generating unit 12 includes: the group generating unit 121 to generate the plurality of groups that satisfy a constraint of the placement optimization problem even if the positions of two or more target factors included in each group of the plurality of groups are swapped on the basis of the original-problem solution; the decision variable setting unit 122 to set a decision variable of a subproblem such that the decision variable corresponds to swapping of the positions of target factors included in each group of the plurality of groups generated by the group generating unit 121; and the objective function setting unit 123 to set an objective function of a subproblem so as to perform evaluation identical to evaluation of an objective function of the placement optimization problem. Thereby, in the optimizing apparatus 10 according to the first embodiment, it is possible to suppress the local search tendency of computation of the placement optimization problem by conversion of it into the subproblem, compared to the conventional technique. In addition, in the optimizing apparatus 10 according to the first embodiment, the subproblem of reduced complexity compared to the conventional technique can be generated, and this leads to enhancement of the searchability due to the reduction of the search space.

In addition, the inverse transforming unit 14 generates a candidate solution to the original problem by applying, to the original-problem solution, a swapping rule of the positions of target factors in each group of the plurality of groups, the swapping rule being designated on the basis of the solution to the subproblem obtained by the subproblem solving unit 13. Thereby, in the optimizing apparatus 10 according to the first embodiment, it is possible to appropriately generate the candidate solution to the original problem on the basis of the solution to the subproblem.

In addition, the group generating unit 121 includes two target factors in each group, the decision variable setting unit 122 allocates a binary decision variable to each group as the decision variable of the subproblem, and a value of the decision variable corresponds to swapping or maintaining the positions of target factors included in a group to which the decision variable is allocated. Thereby, in the optimizing apparatus 10 according to the first embodiment, a change of the decision variable of the subproblem from the original problem becomes possible, the bias in the solution space of the subproblem is reduced compared to the conventional technique, and the local search tendency is suppressed compared to the conventional technique.

In addition, the objective function of the subproblem set by the objective function setting unit 123 is formulated by a quadratic unconstrained binary optimization problem (QUBO). Thereby, in the optimizing apparatus 10 according to the first embodiment, computation by quantum annealing of a quadratic unconstrained binary optimization problem that might otherwise result in performance deterioration due to constraints becomes easier.

In addition, the subproblem solving unit 13 solves the subproblem using one or more selected from quantum annealing in an approximate solution method, an evolutionary computation algorithm, and a mixed integer linear programming method in an explicit solution technique. Thereby, the solution to the subproblem can be calculated accurately in the optimizing apparatus 10 according to the first embodiment.

Note that the present disclosure allows modifications of any constituent elements in the embodiment or omissions of any constituent elements in the embodiment.

### INDUSTRIAL APPLICABILITY

The present disclosure makes it possible to suppress the local search tendency of computation of a combinatorial optimization problem by conversion of the combinatorial optimization problem into a subproblem, compared to the conventional technique, and is suited for used in an optimizing apparatus and an optimization method.

### REFERENCE SIGNS LIST

10: Optimizing apparatus; 11: Initial solution generating unit; 12: Subproblem generating unit; 13: Subproblem solving unit; 14: Inverse transforming unit; 15: Solution updating unit; 20: Input interface; 21: Output interface; 22: Processing circuitry; 23: Processor; 24: Memory; 121: Group generating unit; 122: Decision variable setting unit; 123: Objective function setting unit

1. An optimizing apparatus comprising:
processing circuitry configured to
acquire an original-problem solution which is a solution satisfying a constraint of a combinatorial optimization problem including a plurality of target factors to be combined;
generate a subproblem by dividing the plurality of target factors into a plurality of groups on a basis of the original-problem solution;
find a solution to the subproblem generated;
generate a candidate solution to the original problem on a basis of the obtained solution to the subproblem; and
determine whether it is possible or not possible to update the original-problem solution on a basis of a result of comparison between the generated candidate solution and the acquired original-problem solution.

2. The optimizing apparatus according to claim 1, wherein
the processing circuitry is configured to determine whether or not a predetermined end condition is satisfied after the determination as to whether it is possible or not possible to perform the updating, and, in a case where it is determined that the end condition is not satisfied, generates a new subproblem on a basis of the original-problem solution after the determination as to whether it is possible or not possible to perform the updating.

3. The optimizing apparatus according to claim 1, wherein
the combinatorial optimization problem is a placement optimization problem, and
the processing circuitry is further configured to
generate the plurality of groups that satisfies a constraint of the placement optimization problem even if positions of two or more target factors included in each group of the plurality of groups are swapped on a basis of the original-problem solution;
set a decision variable of the subproblem in such a manner as to correspond to swapping of positions of target factors included in each group of the plurality of groups having been generated; and
set an objective function of the subproblem so as to perform evaluation identical to evaluation of an objective function of the placement optimization problem.

4. The optimizing apparatus according to claim 3, wherein
the processing circuitry is further configured to generate the candidate solution to the original problem by applying, to the original-problem solution, a swapping rule of positions of target factors in each group of the plurality of groups, the swapping rule being designated on the basis of the solution to the subproblem obtained.

5. The optimizing apparatus according to claim 3, wherein
the processing circuitry is further configured to include two target factors in each group of the plurality of groups,
allocate a binary decision variable to each group of the plurality of groups as the decision variable of the subproblem, and
a value of the decision variable corresponds to swapping or maintaining positions of target factors included in a group to which the decision variable is allocated.

6. The optimizing apparatus according to claim 3, wherein
the objective function of the subproblem being set is formulated by a quadratic unconstrained binary optimization problem (QUBO).

7. The optimizing apparatus according claim 1, wherein
the processing circuitry is further configured to solve the subproblem using one or more selected from quantum annealing in an approximate solution method, an evolutionary computation algorithm, and a mixed integer linear programming method in an explicit solution technique.

8. An optimization method performed by an optimizing apparatus, the optimization method comprising:
acquiring an original-problem solution which is a solution satisfying a constraint of a combinatorial optimization problem including a plurality of target factors to be combined;
generating a subproblem by dividing the plurality of target factors into a plurality of groups on a basis of the original-problem solution;
finding a solution to the generated subproblem;
generating a candidate solution to the original problem on a basis of the obtained solution to the subproblem; and
determining whether it is possible or not possible to update the original-problem solution on a basis of a result of comparison between the generated candidate solution and the acquired original-problem solution.

9. A non-transitory computer readable medium with an executable program stored thereon, wherein the program instructs a computer to perform:
acquiring an original-problem solution which is a solution satisfying a constraint of a combinatorial optimization problem including a plurality of target factors to be combined;
generating a subproblem by dividing the plurality of target factors into a plurality of groups on a basis of the original-problem solution;
finding a solution to the subproblem having been generated;
generating a candidate solution to the original problem on a basis of the solution to the subproblem having been obtained; and
determining whether it is possible or not possible to update the original-problem solution on a basis of a result of comparison between the generated candidate solution and the acquired original-problem solution.
